(19) United States
(12) Patent Application Publication
(10) Pub. No.: US 2004/0244832 A1
(43) Pub. Date: Dec. 9, 2004

(54) Roll-over valve

(76) Inventors: Michael Sonnleitner, Kirchdorf an der Kre (AT); Manfred Graf, Bachmanning (AT)

Correspondence Address: BOMBARDIER RECREATIONAL PRODUCTS INC, INTELLECTUAL PROPERTY DEPT, PO BOX 230, NORTON, VT, 05907-0230, US

(21) Appl. No.: 10/807,145

(22) Filed: Mar. 24, 2004

Related U.S. Application Data
(60) Provisional application No. 60/456,473, filed on Mar. 24, 2003.
(60) Provisional application No. 60/539,103, filed on Jan. 27, 2004.

(51) Int. Cl. F16K 17/36

(52) U.S. Cl. 137/38

(57) ABSTRACT

A roll-over valve for a blow-by gas circulation system of an engine includes a piston slidably mounted within a valve housing. A lateral inlet opening and an outlet opening are disposed in the valve housing. When the valve is upright, fluid flows freely from the inlet opening to the outlet opening through the valve housing. When the valve overturns, the piston moves axially within the valve housing under the force of gravity into a roll-over position. When the piston is in the roll-over position, it blocks the fluid path between the inlet and outlet lines to close the valve. The inlet opening is positioned such that pressure in the inlet opening does not impede the movement of the piston. An air bleed passage fluidly connects portions of the valve housing that are above and below the piston and dampens movement of the piston within the valve housing.

### CROSS REFERENCE TO RELATED APPLICATIONS

This application relates to and claims the benefit of U.S. Provisional Patent Application No. 60/456,473, filed on Mar. 24, 2003, which is incorporated herein by reference. This application also relates to and claims the benefit of U.S. Provisional Patent Application No. 60/539,103, filed Jan. 27, 2004, which is incorporated herein by reference.

### BACKGROUND OF THE INVENTION

1. Field of the Invention

This invention relates to roll-over valves that are used on vehicles to prevent fluid flow through fluid lines when the vehicle is overturned. This invention specifically relates to roll-over valves that are disposed in blow-by gas lines to prevent oil in an oil tank from flowing into an engine when the vehicle overturns.

2. Description of Related Art

Roll-over valves are typically used to prevent lubricating oil (or a combination of oil, fuel, and air (i.e., blow-by gas)) from flowing out of the crank case or the oil tank and through a blow-by gas line into the engine induction port or the environment if a motor vehicle overturns. Various types of vehicles, such as all-terrain vehicles (ATV), snowmobiles, recreational watercraft, and personal watercraft (PWC) use such roll-over valves. Roll-over valves are particularly important for personal watercraft, which can roll over because of the manner in which they are driven and are nonetheless required to comply with very strict environmental regulations.

Solenoid valves and sensors are typically used as roll-over valves. When the solenoid is not energized, the valve is held in a closed position by at least one spring so that the valve blocks the blow-by gas line. Once the ignition for the internal combustion engine is turned on, the solenoid is energized and the valve opens, thereby opening the blow-by line. A sensor on the vehicle senses when the vehicle overturns and accordingly de-energizes the solenoid. The solenoid valve closes under the force of the spring. U.S. Pat. No. 6,626,140 describes one such solenoid-based roll-over valve.

One disadvantage of a solenoid-based roll-over valve is that solenoids consume a lot of power (approximately 5 amperes). The vehicle's engine must therefore use part of its horsepower to power a generator that powers the solenoid. This power drain on the engine is particularly disadvantageous when the engine is started cold, because the starter has to draw a great deal of power from the vehicle battery to energize the solenoid. Another disadvantage of solenoid-based roll-over valves is that they become extremely hot because of their significant power dissipation. They cannot, therefore, be used in the vicinity of fuel lines. A further disadvantage of solenoid-based roll-over valves is that they are expensive because of the technical complexity of the solenoid valve and sensor.

U.S. Pat. No. 6,419,531 describes a simple, mechanical roll-over valve that is operated by gravity. The roll-over valve includes a check valve with a ball. If a vehicle, in particular a personal watercraft, rolls over, the ball falls against a seat and blocks the blow-by gas line. When the watercraft rolls upright again, the ball is designed to fall back down and open the blow-by gas line. In practice, however, the ball frequently stays seated in the seat even after the watercraft rolls upright. The roll-over valve therefore remains closed and the back pressure that develops in the blow-by gas line can damage the engine as well as components of the blow-by gas circulation system. Furthermore, while the vehicle is overturned, if the engine continues to operate, the blow-by gas line is blocked so that blow-by gas builds up in the engine and can damage the engine.

### SUMMARY OF THE INVENTION

Accordingly, one aspect of one or more embodiments of the present invention provides a simple, cost effective roll-over valve that does not drain engine horsepower.

Another aspect of one or more embodiments of the present invention provides a roll-over valve for an engine blow-by gas system that allows blow-by gas to flow from the engine back to the engine intake even when the engine is overturned.

Another aspect of one or more embodiments of the present invention provides a blow-by gas circulation system that allows blow-by gas to flow from the engine crankcase or oil tank to the engine's intake system when the engine is overturned, while simultaneously preventing oil from flowing from the engine crankcase or oil tank to the engine's intake system. This ensures that in the event of a rollover, blow-by gas can still flow from the crank case to the intake system so that the engine can continue to operate overturned without causing blow-by gas pressure to damage the engine or blow-by gas system, and without causing significant amounts of oil to drain from the crankcase or oil tank into the engine's intake system.

Another aspect of one or more embodiments of the present invention provides a device for closing a blow-by gas line that is simple to manufacture, contains only a few moving parts, and is reliable.

Another aspect of one or more embodiments of the present invention provides a simple, gravity-driven, mechanical roll-over valve.

Another aspect of one or more embodiments of the present invention provides a roll-over valve for a blow-by gas circulation system of an engine. The valve includes a valve housing having an inner chamber that defines an axis, an inlet opening disposed in a lateral side of the valve housing, and an outlet opening disposed in the valve housing. The valve housing also includes a piston slidingly disposed in the inner chamber for movement relative to the valve housing along the axis. The piston has normal and roll-over positions relative to the valve housing. The inlet and outlet openings fluidly connect to each other via the inner chamber when the piston is in the normal position. The piston slides from its normal position to its roll-over position under the force of gravity when the valve rolls into an overturned position. The piston blocks at least one of the inlet and outlet openings to prevent fluid flow through the inner chamber when the piston is in its roll-over position.

According to a further aspect of one or more embodiments of the present invention, the valve also includes a blow-off valve fluidly connecting the inlet and outlet openings such that the blow-off valve opens when a pressure in the inlet opening exceeds a predetermined pressure relative to a pressure in the outlet opening. The blow-off valve closes when the pressure in the inlet opening falls below the predetermined pressure.

According to a further aspect of one or more embodiments of the present invention, the valve includes an air-bleed passage that fluidly connects portions of the inner chamber that are disposed on opposing axial sides of the piston. The air-bleed passage may include an orifice that dampens movement of the piston relative to the valve housing. The air-bleed passage may have first and second opposing ends, wherein the first end of the air-bleed passage fluidly connects to a bottom axial portion of the inner chamber such that the first end aligns with the axis. The second end of the air-bleed passage fluidly connects to the outlet opening. The air-bleed passage may include an axially extending bore in the piston.

According to a further aspect of one or more embodiments of the present invention, the valve includes an inner piston slidingly disposed in the bore. The inner piston has normal and roll-over positions relative to the piston, and blocks the air-bleed passage when the inner piston is in its roll-over position. The inner piston may have a guiding portion that has a polygonal cross-section that guides the inner piston along the axis of the bore. The guiding portion may have a cross-sectional area that is at least 85% of a cross-sectional area of the surrounding bore. The inner piston may have a frusto-conical upper surface. An upper portion of the bore may have a reduced diameter frusto-conical surface that seals against the frusto-conical upper surface of the inner piston when the inner piston moves into its roll-over position.

According to a further aspect of one or more embodiments of the present invention, the inlet opening connects to the inner chamber at a position where any pressure that develops in the inlet opening does not urge the piston into the roll-over position.

According to a further aspect of one or more embodiments of the present invention, the inlet opening includes an opening in the side of the valve housing.

According to a further aspect of one or more embodiments of the present invention, the inlet opening includes a plurality of inlet openings that are evenly circumferentially spaced from each other in the side of the valve housing.

According to a further aspect of one or more embodiments of the present invention, a portion of the piston has a cylindrical outer surface. The outlet opening may be disposed at an upper axial end of the inner chamber. An upper portion of the piston may have a frusto-conical surface. The outlet opening may have a frusto-conical surface that seals against the frusto-conical surface of the piston when the piston is in the roll-over position.

According to a further aspect of one or more embodiments of the present invention, the inlet and outlet openings are disposed at the same axial position along the valve housing.

Another aspect of one or more embodiments of the present invention provides a roll-over valve according to the present invention in combination with a blow-by gas circulation system. The system has an oil tank with an inlet adapted to accept blow-by gas from an engine, and an upper portion that is adapted to be above an oil level in the oil tank when the oil tank is upright. The system also includes an oil separator having an inlet adapted to accept blow-by gas, and an outlet adapted to direct blow-by gas to an intake system of the engine. The system further includes a blow-by gas line fluidly connecting the upper portion of the oil tank to the inlet of the oil separator. The roll-over valve is disposed in the blow-by gas line such that the inlet opening fluidly connects to the upper portion of the oil tank and the outlet opening fluidly connects to the inlet of the oil separator.

Another aspect of one or more embodiments of the present invention provides a blow-by gas system that includes an oil tank having an inlet adapted to accept blow-by gas from an engine, an upper portion that is adapted to be above an oil level in the oil tank when the oil tank is upright, and a lower portion that is adapted to be above the oil level in the oil tank when the oil tank is overturned. The system also includes an oil separator having an inlet adapted to accept blow-by gas, and an outlet adapted to direct blow-by gas to an intake system of the engine. The system also includes a first blow-by gas line fluidly connecting the upper portion of the oil tank to the inlet of the oil separator. The system also includes a roll-over valve that has a first valve portion that is disposed in the first blow-by gas line. The roll-over valve has upright and overturned positions. The first valve portion opens the first blow-by gas line when the roll-over valve is in the upright position, and closes the first blow-by gas line when the roll-over valve is in the overturned position. The system also includes a second blow-by gas line fluidly connecting the lower portion of the oil tank to the inlet of the oil separator.

According to a further aspect of one or more embodiments of the present invention, the first and second blow-by gas lines converge into a common blow-by gas line before reaching the inlet of the oil separator.

According to a further aspect of one or more embodiments of the present invention, the roll-over valve further includes a second valve portion that is disposed in the second blow-by gas line. The second valve portion closes the second blow-by gas line when the roll-over valve is in the upright position, and opens the second blow-by gas line when the roll-over valve is in the overturned position.

According to a further aspect of one or more embodiments of the present invention, an oil return line fluidly connects the lower portion of the oil tank to the oil separator. The roll-over valve further includes a third valve portion that is disposed in the oil return line. The third valve portion opens the oil return line when the roll-over valve is in the upright position, and closes the oil return line when the roll-over valve is in the overturned position.

According to a further aspect of one or more embodiments of the present invention, the roll-over valve includes a valve housing having an inner chamber and an axis, and a piston slidingly disposed within the inner chamber. The piston is disposed in a normal position when the roll-over valve is in the upright position. The piston moves into a roll-over position when the roll-over valve is in the overturned position. The first valve portion may include a first groove in the piston that aligns with opposing openings in the first blow-by gas line to permit fluid flow through the first blow-by gas line when the piston is in the normal position. The first groove misaligns with the opposing openings in the first blow-by gas line when the piston is in the roll-over position such that the piston prevents fluid flow through the first blow-by gas line.

According to a further aspect of one or more embodiments of the present invention, the roll-over valve further includes a second valve portion that is disposed in the second blow-by gas line. The second valve portion includes a second groove in the piston. The second groove aligns with opposing openings in the second blow-by gas line to allow fluid flow through the second blow-by gas line when the piston is in the roll-over position. The second groove misaligns with the opposing openings in the second blow-by gas line when the piston is in the normal position such that the piston prevents fluid flow through the second blow-by gas line.

According to a further aspect of one or more embodiments of the present invention, the system includes an oil return line fluidly connecting the lower portion of the oil tank to the oil separator. The roll-over valve further includes a third valve portion that is disposed in the oil return line. The third valve portion includes a third groove in the piston that aligns with opposing openings of the oil return line to allow fluid to flow through the oil return line when the piston is in the normal position. The third groove misaligns with the opposing openings in the oil return line when the piston is in the roll-over position such that the piston prevents fluid flow through the oil return line.

According to a further aspect of one or more embodiments of the present invention, the piston has an axial bore extending therethrough. The piston may also have a first radial bore fluidly connecting the first groove to the axial bore. The piston may also have a second radial bore fluidly connecting the third groove to the axial bore.

According to a further aspect of one or more embodiments of the present invention, the outlet of the oil separator extends downwardly into the oil separator such that an oil storage compartment is defined in the oil separator above the lower end of the outlet of the oil separator. The system may also include a drain line fluidly connected to the oil storage compartment.

Another aspect of one or more embodiments of the present invention provides a blow-by gas system that includes an oil tank having an inlet adapted to accept blow-by gas from an engine, an upper portion that is adapted to be above an oil level in the oil tank when the oil tank is upright, and a lower portion that is adapted to be above the oil level in the oil tank when the oil tank is overturned. The system also includes an oil separator having an inlet adapted to accept blow-by gas, and an outlet adapted to direct blow-by gas to an intake system of the engine. The system further includes a first blow-by gas line fluidly connecting the upper portion of the oil tank to the inlet of the oil separator. The system also includes a roll-over valve that has a first valve portion that is disposed in the first blow-by gas line. The roll-over valve has upright and overturned positions. The first valve portion opens the first blow-by gas line when the roll-over valve is in the upright position. The first valve portion closes the first blow-by gas line when the roll-over valve is in the overturned position. An oil return line fluidly connects the lower portion of the oil tank to the oil separator.

Additional and/or alternative advantages and salient features of embodiments of the invention will become apparent from the following detailed description, which, taken in conjunction with the annexed drawings, disclose preferred embodiments of the invention.

### BRIEF DESCRIPTION OF THE DRAWINGS

Referring now to the drawings which from a part of this original disclosure:

FIG. 1 is a partial side diagram of an engine blow-by gas circulation system according to an embodiment of the present invention during normal upright operation;

FIG. 2 is a partial side diagram of the engine blow-by gas system in FIG. 1 during overturned operation;

FIG. 3 is a simplified diagram of a roll-over valve in a normal, upright position according to another embodiment of the present invention;

FIG. 4 is a simplified diagram of the roll-over valve of FIG. 3 in an overturned position;

FIG. 5 is a cross-sectional view of a roll-over valve in a normal, upright position according to another embodiment of the present invention; and

FIG. 6 is a cross-sectional view of the roll-over valve of FIG. 5, taken along the line 6-6 in FIG. 5.

### DETAILED DESCRIPTION OF PREFERRED EMBODIMENTS

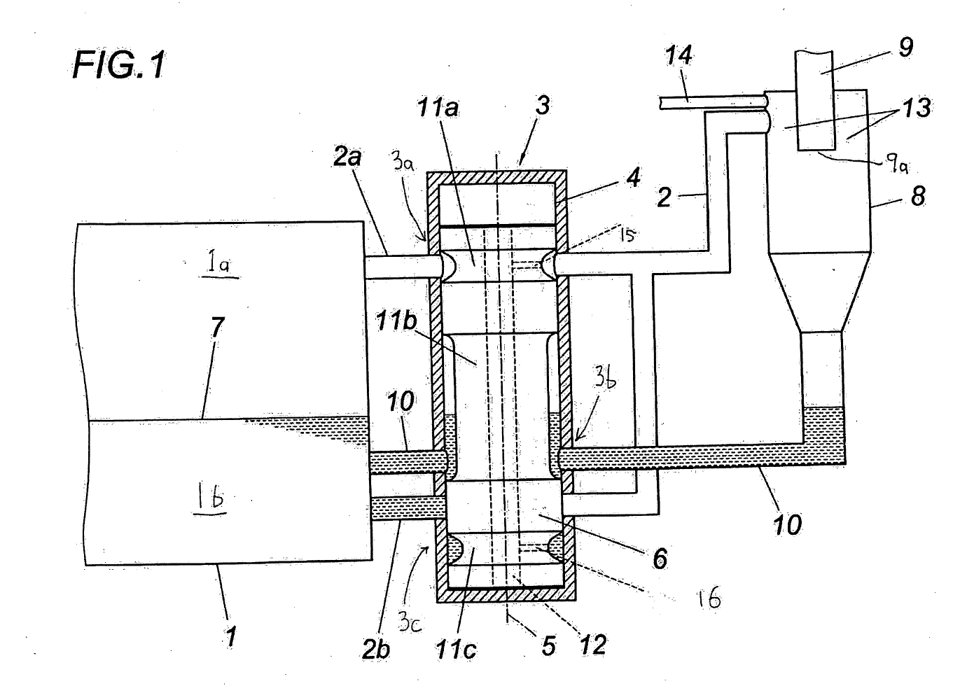

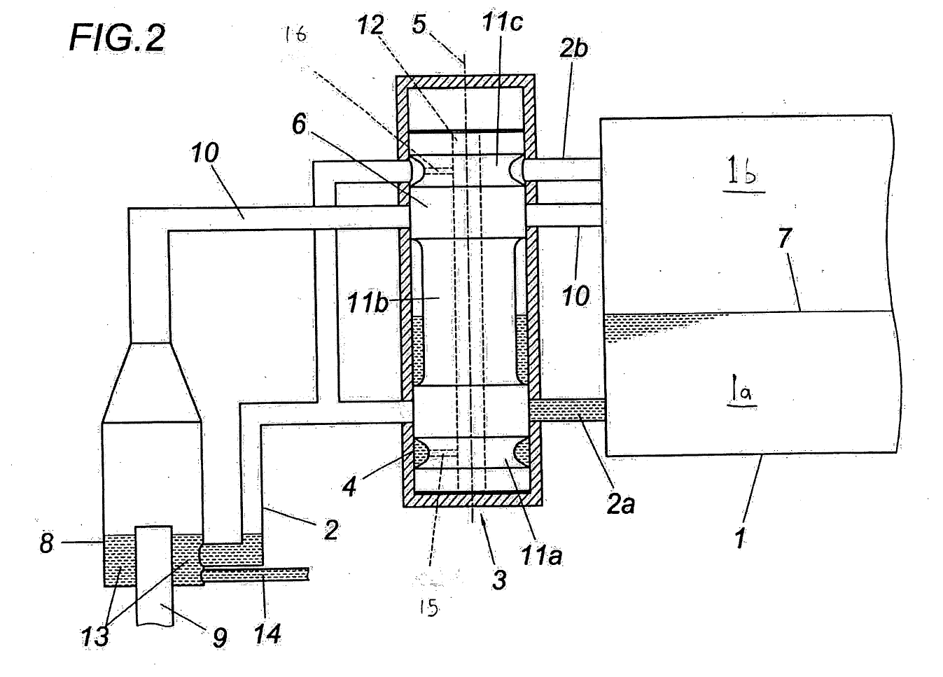

FIG. 1 illustrates a roll-over valve 3 incorporated into a blow-by gas circulation system for an engine of a vehicle such as a personal watercraft, all-terrain vehicle, or snowmobile. The blow-by gas circulation system includes an oil tank 1 that is filled with oil to an oil level 7. An upper portion 1a of the oil tank 1 is fluidly connected to a crankcase or other component of the engine so that blow-by gas and lubricant that builds and collects in the engine can flow into the oil tank 1. In the oil tank 1, some of the lubricant in the blow-by gas separates and collects in the lower portion 1b. A first blow-by gas line 2a fluidly connects the upper portion 1a of the oil tank 1 to an oil separator 8 by way of the valve 3. The separator 8 is preferably a cyclone oil separator. The upper portion 1a of the oil tank 1 is designed to be above the oil level 7 when the oil tank is upright (see FIG. 1). A second blow-by gas line 2b fluidly connects a lower portion 1b of the oil tank 1 to the oil separator 8 by way of the valve 3. The lower portion 1b of the oil tank 1 is designed to be above the oil level 7 when the oil tank is overturned (see FIG. 2). The first and second blow-by gas lines 2a, 2b converge into a single common blow-by gas line 2 between the valve 3 and the oil separator 8.

An oil return line 10 fluidly connects a lower portion of the oil separator 8 to the oil tank 1 by way of the roll-over valve 3 to return separated oil back to the oil tank 1. The oil return line 10 may alternatively extend between the oil separator 8 and the engine's crankcase without deviating from the scope of the present invention.

A blow-by gas return line 9 fluidly connects the oil separator 8 to an intake or induction tract of the engine to return partially cleaned blow-by gas to the engine's intake. As shown in FIG. 2, an inlet end 9a of the blow-by gas return line 9 is positioned in the oil separator 8 at a low enough position that an oil storage compartment 13 is defined in the oil separator 8 above the inlet end 9a between the inlet end 9a and an upper inside end of the cyclone oil separator 8. The oil storage compartment 13 stores oil in the oil separator 8 when the vehicle overturns, and therefore prevents residual oil in the oil separator 8 or nearby lines 2, 10 from entering the engine through the blow-by gas return line 9. A drain line 14 fluidly connects the oil storage compartment 13 to a surge tank, a crank case of the engine, or some other area where excess oil may be safely stored when the vehicle overturns.

As shown in FIG. 1, the roll-over valve 3 comprises a piston 6 that can move freely within a valve housing 4 in the direction of an axis 5. While the valve housing 4 preferably has a cylindrically shaped interior chamber, other configurations are contemplated and considered to be well within the scope of the present invention. The shape of the valve housing 4 is governed by the shape of the piston 6. When the vehicle is upright, the piston 6 is in a normal position, as shown in FIG. 1. A first groove 11 a in the piston 6 defines a first valve portion 3a of the valve 3. In the normal position, the first groove 11 a is aligned with opposing portions of the blow-by gas line 2a so that the line 2a is open and blow-by gas can flow from the oil tank 1 to the cyclone oil separator 8 through the blow-by gas line 2a. The opposing sides of the blow-by gas line 2a that connect to the valve 3 are disposed at the same axial position along the valve housing 4 as each other. A second groove 11b in the piston 6 defines a second valve portion 3b of the valve 3. In the normal position, the second groove 11b in the piston 6 is aligned with the oil return line 10 so that the return line 10 is open and separated oil can flow from the oil separator 8 back into the oil tank 1. A third groove 11c in the piston 6 defines a third valve portion 3a of the valve 3. In the normal position, the third groove 11c is not aligned with the second blow-by gas line 2b so that the second blow-by gas line 2b is closed. The grooves 11a, 11b, 11c are preferably annular. The shape of the grooves 11a, 11b, 11c is governed by the shape of the valve housing 4 as well as the shape and location of the connections between the valve housing 4 and the connected fluid lines 2a, 2b, 10.

FIG. 2 shows the blow-by gas circulation system when the vehicle is overturned. The piston 6 moves into a roll-over position within the valve housing 4 under the force of gravity. In the roll-over position, the third groove 11c aligns with the second blow-by gas line 2b. The second blow-by gas line 2b connects to the lower portion 1b of the oil tank 1, which is above the oil level 7 in the oil tank 1 when the vehicle is overturned. Accordingly, while blow-by gas in the oil tank 1 can flow through the line 2b into the oil separator 8, oil does not. Although the oil separator 8 does not separate oil from the blow-by gas when it is overturned, blow-by gas can nonetheless flow from the engine back into the engine's intake through the blow-by gas circulation system. The engine can therefore operate in an overturned position without having blow-by gas pressure build up and possibly damage the engine or the blow-by gas circulation system.

As shown in FIG. 2, when the piston 6 is in the roll-over position, the grooves 11a, 11b do not align with the first blow-by gas line 2a or the oil return line 10 so that the gas line 2a and oil return line 10 are closed. This prevents oil in the upper portion 1a of the oil tank 1 from flowing through the gas line 2a or oil return line 10 into the oil separator 8 when the vehicle is overturned.

As shown in FIG. 2, if the vehicle overturns, any residual oil in the oil lines 2a, 10 and any oil that leaks from the piston 6 can collect in the storage compartment 13 of the oil separator 8 and drain off through the drain line 14 without flowing into the engine's intake through the blow-by gas return line 9.

As shown in FIGS. 1 and 2, the blow-by gas lines 2a, 2b and oil return line 10 connect to lateral sides of the valve housing 4 so that any pressure that develops in the lines 2a, 2b, 10 pushes the piston 6 in a direction that is perpendicular to the axial direction of travel of the piston 6. Pressure in the lines 2a, 2b, 10 therefore does not affect the movement of the piston 6 and the piston 6 is free to move between its normal and roll-over positions under the force of gravity, alone. Conversely, as discussed above in the Background, back pressure in conventional blow-by gas lines frequently locks conventional roll-over valves in their overturned positions even after the conventional valves return to their upright positions.

A central bore 12 extends through the piston 6 along the axis 5. Additional radial bores 15, 16 extend between the grooves 11a, 11c and the central bore 12. These bores 12, 15, 16 act as an air bleed passage that ensures that pressure does not build up on either axial end of the piston 6 or bias the piston 6 in any direction. The piston 6 can therefore freely move within the valve housing 4 under the force of gravity. The bores 12, 15, 16 also keep the valve housing 4 at least partially filled with oil. The grooves 11a, 11b, 11c may also remain partially filled with oil. The oil in the valve housing 4 dampens movement of the piston 6. The bore 12 functions as an orifice to limit the speed that fluid can flow therethrough. The bore 12 therefore dampens the movement of the piston 6 by limiting the speed at which pressure in the valve housing 4 on opposite axial ends of the piston 6 can equalize. The bore 12 is designed so that the damping action is strong enough that the piston 6 does not move into the roll-over position when subjected to the bumps, shocks, oscillations, and vibrations of ordinary upright vehicle operation (e.g. bumps or rough terrain in the case of ATVs or snowmobiles and rough waves in the case of PWCs). It is intended that the piston 6 move into its roll-over position only in the event of a rollover.

While the illustrated valve 3 includes valve portions 3a, 3b, 3c for each of the first blow-by gas line 2a, oil return line 10, and second blow-by gas line 2b, respectively, one or more of these individual valves 3a, 3b, 3c can be eliminated without deviating from the scope of the present invention. For example, if the oil return line 10 is connected to the lower portion 1b of the oil tank 1, the valve portion 3b may be omitted and the oil return line 10 may remain always open such that the oil return line 10 functions as a blow-by gas line when the vehicle overturns. Similarly, if the gas lines 2a, 2b converge into the common line 2 at a point that is elevated relative to the oil level 7 when the oil tank 1 is upright, the second blow-by gas line 2b may bypass the valve 3, the third valve portion 3c may be omitted, and the second blow-by gas line 2b may remain always open. Furthermore, the oil return line 10 and the second blow-by gas line 2b may be integrated so that their individual valve portions 3b, 3c may be combined into a single valve portion.

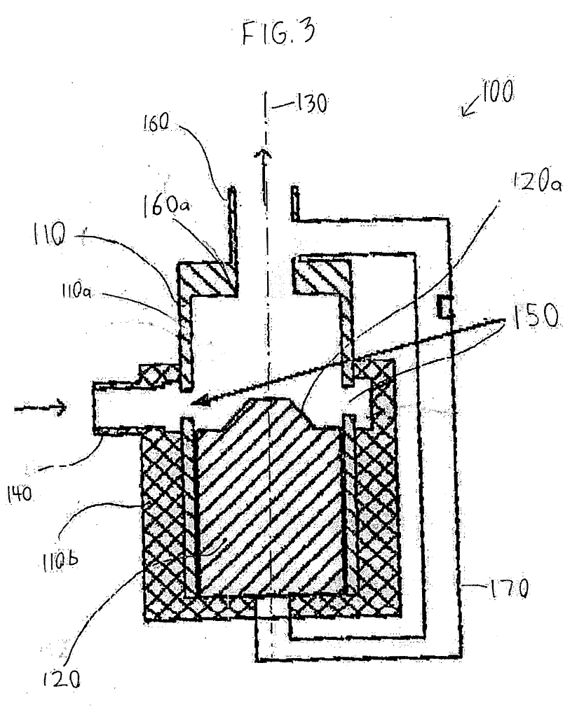

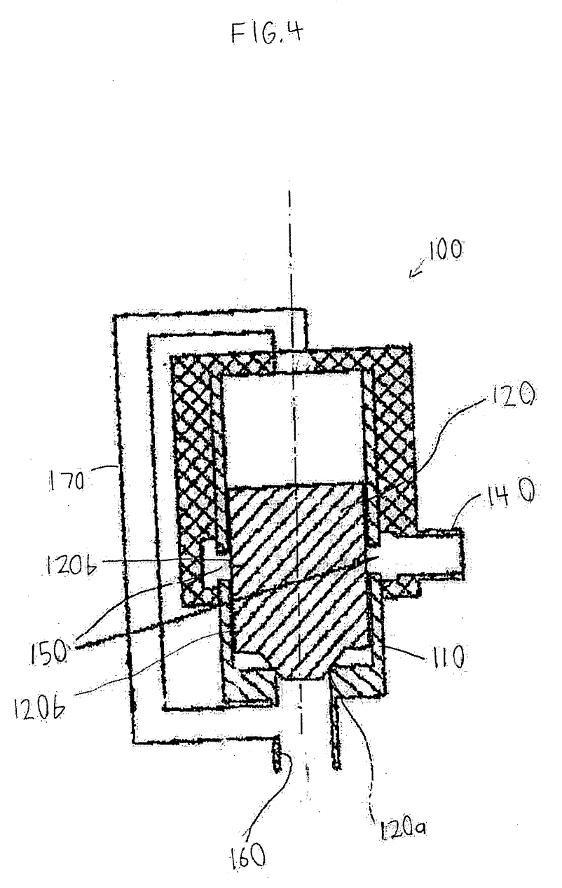

FIGS. 3 and 4 illustrate a roll-over valve 100 according to another embodiment of the present invention. The roll-over valve 100 or a plurality of roll-over valves 100 may replace any one or more of the valve portions 3a, 3b, 3c of the embodiment illustrated in FIG. 1 without deviating from the scope of the present invention. The roll-over valve 100 includes a valve housing 110 and a piston 120 that freely moves within the valve housing 110 along an axis 130. The valve housing 110 comprises an inner housing 10a and an outer housing 10b. The valve housing 110 preferably has a cylindrical shape, but other configurations are considered to be well within the scope of the present invention. The piston 120 has a sealing surface 120a on its upper axial end. A lateral inlet line 140 fluidly connects to the valve housing 110 by way of a channel (or inlet opening) 150 formed in a wall of the valve housing 110. The channel 150 is preferably an annular channel. The inlet line 140 fluidly connects to an oil tank as described in the previous embodiment. The channel 150 surrounds the lateral side of the piston 120 to ensure that pressure in the inlet 140 acts equally on all sides of the piston 120 so that the piston 120 can freely move in the valve housing 110 regardless of the pressure in the inlet line 140. An outlet line 160 includes an outlet opening 160a disposed at an upper axial end of the valve housing 110. The outlet line 160 fluidly connects to an inlet of an oil separator, as described in the previous embodiment.

An air bleed line (or passage) 170 fluidly connects upper and lower ends of the valve housing 110. The connection between the air bleed line 170 and the lower end of the valve housing 110 is aligned with the axis 130 of the valve housing 110. The air bleed line 170 ensures that the pressure in the valve housing 110 above and below the piston 120 remains roughly equal so that the piston 120 can freely axially move within the valve housing 110. The air-bleed line 170 preferably has a small enough inner cross-sectional area that it functions as an orifice that dampens the movement of the piston 120 relative to the valve housing 110.

As illustrated in FIG. 3, during normal, upright operation of the roll-over valve 100, the axis 130 extends vertically, and the piston 120 rests on a lower part of the valve housing 110 under the downward force of gravity. The inlet 140 fluidly connects to the outlet 160 via the groove 150 and the interior of the valve housing 110.

As shown in FIG. 4, if the roll-over valve 100 overturns so that its upper end faces down, the piston 120 slides downwardly under the force of gravity into its roll-over position. When the piston 120 is in the roll-over position, the sealing surface 120a of the piston seals against the upper end of the valve housing 110 to prevent fluid communication between the valve housing 110 and the outlet 160. The roll-over valve 100 is therefore closed and prevents fluid from flowing from the inlet 140 to the outlet 160.

While the illustrated embodiment relies on the sealing surface 120a to close the valve 100, the valve 100 may alternatively and/or additionally rely on a sealing surface 120b formed on the circumference of the piston 120 to close the valve 100. When the piston 120 is in the roll-over position, the sealing surface 120b blocks the inlet 140 and groove 150 from fluidly communicating with the interior of the valve housing 110. The sealing surface 120b may comprise a tight clearance between the piston 120 and valve housing 110 or may comprise one or more sealing rings disposed between the circumferential edge of the piston 120 and the valve housing 110. If the sealing surface 120b is relied upon to close the valve 100, the air bleed line 170 may be replaced by an axial bore formed in the piston 120, as is described with respect to the previous embodiment.

If the closed roll-over valve 100 returns to its normal upright position, the piston 120 returns to its normal position (see FIG. 3) under the force of gravity and reopens the valve 100.

The channel 150 ensures that pressure in the inlet line 140 acts equally on all sides of the piston 120 so that pressure that builds up in the channel 150 does not impede movement of the piston 120b. Moreover, pressure in the channel 150 that acts against the side of the piston 120 in a direction that is perpendicular to the direction of travel of the piston 120 so that the pressure does not affect the movement of the piston 120.

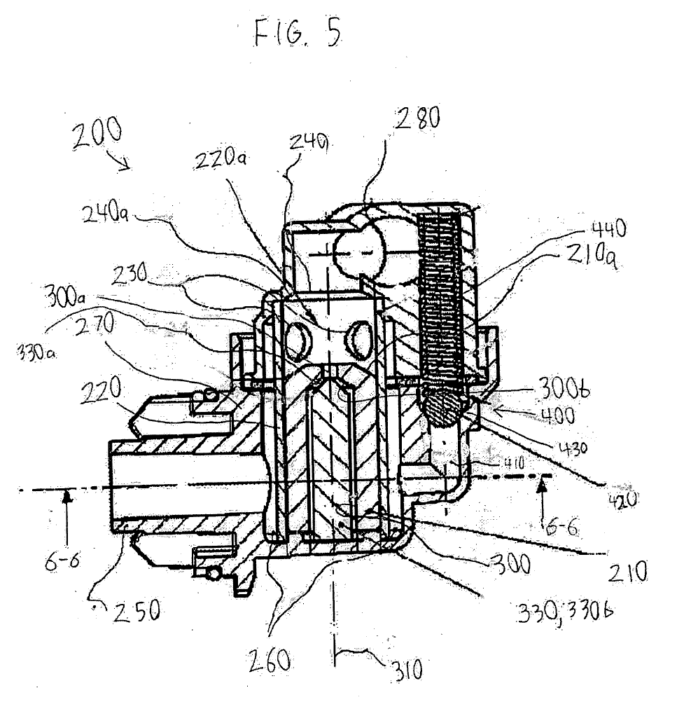

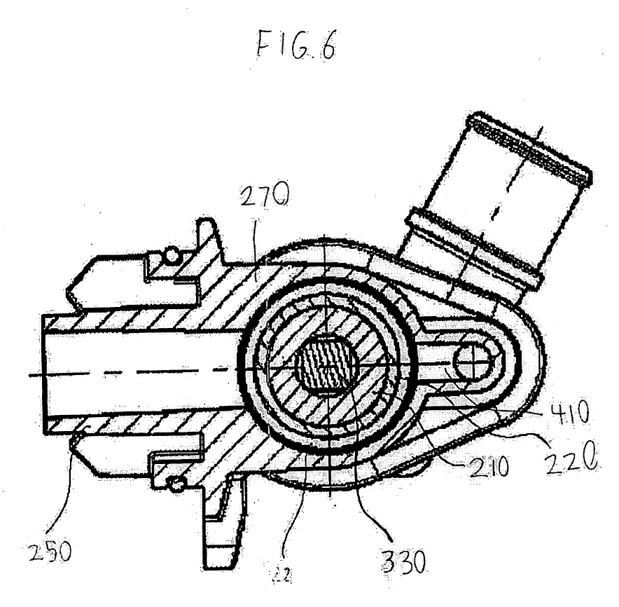

FIGS. 5 and 6 illustrate a roll-over valve 200 according to another embodiment of the present invention. The roll-over valve 200 comprises a valve housing 270, a cylinder (or inner valve housing) 220 mounted within the valve housing 270, an outer piston 210 slidingly disposed within the cylinder 220, and an inner piston 330 slidingly disposed within a bore 300 in the outer piston 210.

An inlet line 250 of the valve 200 is fluidly connected to an oil tank, as is described in the previous embodiments. The inlet line 250 in the valve housing 270 fluidly connects to a channel 260 that is formed between the valve housing 270 and an outer surface of the cylinder 220. The channel 260 is preferably an annular channel. The channel 260 partially surrounds the cylinder 220. A plurality of lateral inlet openings 230 are evenly circumferentially spaced from each other around the upper side of the cylinder 220. The lateral inlet openings 230 fluidly connect the channel 260 to an inner chamber 220a of the cylinder 220. The even spacing ensures that pressure that develops in the inlet openings 230 acts evenly around the circumference of the outer piston 210 so that inlet pressure does not impede the movement of the outer piston 210. Alternatively, the lateral inlet openings 230 may be replaced by a single continuous annular opening as is described in the previous embodiment.

An outlet line 280 in the valve housing 270 is fluidly connected to an oil separator (not shown in this embodiment). The outlet line 280 defines an outlet opening 240 that fluidly connects to an upper axial end of the inner chamber 220a. When the valve 200 is open, fluid flows from the oil tank, through the inlet line 250, through the channel 260, through the lateral openings 230 into the inner chamber 220a of the cylinder 220, through the outlet opening 240, through the outlet line 280, and finally into the oil separator.

The outer piston 210 is arranged within the inner chamber 220a of the cylinder 220 and moves freely along an axis 310 of the cylinder 220. FIG. 5 illustrates the outer piston 210 in a normal, open position. In the normal position, fluid can freely flow through the valve 200. When the valve 200 overturns, gravity forces the outer piston 210 into a roll-over position in which the outer piston 210 rests against the outlet opening 240. In the roll-over position, a frusto-conical sealing surface 210a formed on the upper axial end of the outer piston 210a seals against a complementary frusto-conical sealing surface 240a formed on the outlet opening 240 to prevent fluid from flowing through the outlet opening 240. The outer circumferential surface of the outer piston 210 may include a sealing surface that seals against the lateral openings 230 to prevent fluid from flowing through the lateral openings 230 into the inner chamber 220a when the outer piston 210 is in the roll-over position.

The axial bore 300 extends upwardly into the outer piston 210 along the axis 310. The bore 300 has a reduced diameter upper opening (or air bleed hole) 300a. The bore 300 serves as an air-bleed device that ensures that pressure in the cylinder 220 above and below the outer piston 210 remains roughly equal so that the outer piston 210 can freely move within the inner chamber 220a. The reduced diameter of the air bleed hole 330a makes the air bleed hole 330a act as an orifice that limits fluid flow therethrough and thereby dampens the movement of the outer piston 210 relative to the cylinder 220. This dampening ensures that the valve 200 does not prematurely close under the jostling and vibrations of normal, upright, vehicle use.

The inner piston 330 slidingly engages the bore 300 in the outer piston 210. The inner piston 330 is preferably heavier than the outer piston 210. For example, the inner piston 330 may comprise steel, while the outer piston 210 may comprise a lighter material such as aluminum.

The inner piston 330 moves freely within the bore 300 relative to the outer piston 210 under the force of gravity. As shown in FIG. 6, the inner piston has a guiding portion 330b with a hexagonal cross-section that allows fluid to flow axially between the inner piston 330 and the bore 300. A cross-sectional area of the guiding portion 330b is preferably at least 85% of a cross-sectional area of the bore 300 that surrounds the guiding portion 330b. The hexagonal cross-section of the guiding portion 330b also minimizes friction between the inner and outer pistons 330, 210. The hexagonal cross-section maybe replaced by a variety of other polygonal, curved, or angled shapes without deviating from the scope of the present invention. An upper axial end of the inner piston 330 includes a conical or frusto-conical sealing surface 330a that seals against a frusto-conical sealing surface 300b formed at the upper opening 300a of the bore 300 when gravity forces the pistons 210, 330 against each other.

If the orientation of the valve 200 changes in such a way that gravity causes the pistons 210, 330 to move in the direction of the roll-over position of the outer piston 210, the pistons 210, 330 move simultaneously or sequentially into their roll-over positions. If sufficient fluid escapes from the chamber 220a above the pistons 210, 330 through the outlet opening 240, the inner piston 330 remains seated against the outer piston 210 and the pistons 210, 330 simultaneously move into their roll-over positions. However, if sufficient fluid cannot escape through the outlet opening 240, the outer piston 210 moves into the roll-over position first. During this axial movement of the outer piston 210, fluid flows through the air bleed hole 300a to equalize pressure in the inner chamber 220a above and below the outer piston 210. During this fluid flow and movement of the outer piston 210, the sealing surface 330a of the inner piston 330 remains spaced from the sealing surface 300b of the upper opening 300a due to the air pressure in the air bleed hole 300a. The outer piston 210 comes to rest against the outlet opening 240 and closes the valve 200, as has been described in principle for the embodiment shown in FIGS. 3 and 4. After the outer piston 210 moves into its roll-over position, air stops moving through the air bleed hole 300a and the inner piston 330 comes to rest against the air bleed hole 300a under the force of gravity to seal the air bleed hole 300a.

Both the upper opening 300a and the outlet opening 240 remain blocked as long as gravity forces the pistons 210, 330 into their roll-over positions against the outlet opening 240 and the air bleed hole 300a, respectively. If the orientation of the valve 200 changes so that gravity urges the pistons 210, 330 back into their normal positions (shown in FIG. 5), the inner piston 330 begins to move downwardly back into its normal position before the outer piston 210 preferably due to one or more of the following factors: (a) the relatively low friction between the inner piston's hexagonal cross section and the bore 300, (b) the relatively heavy weight of the inner piston 330, and (c) the relatively small cross-sectional area of the inner piston 330, which limits any pressure below the inner piston 330 that might urge the inner piston 330 toward its roll-over position. The outer piston 210 begins to move downwardly into its normal position after the inner piston 330 moves away from and opens up the air bleed valve 300a, thereby releasing air pressure that may have developed in the inner chamber 220a below the outer piston 210. The combination of the inner and outer pistons 330, 210 dampens the movement of the outer piston 330. The combination of two pistons 210, 300 also helps to ensure that the valve 200 reopens when it returns to its upright position, despite any pressure that may have developed in the inner chamber 220a below the pistons 210, 330 while the pistons 210, 330 were in their roll-over positions.

The valve 200 also includes a safety blow-off valve 400. The blow-off valve 400 includes a by-pass passage 410 that fluidly extends between the channel 260 and the outlet line 280. The blow-off valve 400 also includes a sealing body 420, which is a ball in the illustrated embodiment. The sealing body 420 is pressed against a seal seat 430 formed in the by-pass passage 410 by a preloaded spring 440. When a predetermined pressure builds up in the channel 260, the pressure against the sealing body 420 exceeds the counteracting pressure of the spring 440 and the sealing body unseats from the seal seat 430, thereby opening the blow-off valve 400. The blow-off valve 400 closes when the pressure in the channel 260 falls below the predetermined pressure.

During normal operation of the valve 200, fluid flows from the inlet line 250 to the outlet line 280 through the inner chamber 220a of the cylinder 220. However, when the valve 200 is in the roll-over position, fluid flow through the inner chamber 220a is blocked. If the valve 200 is incorporated into a blow-by gas circulation system and the engine continues to operate, blow-by gas pressure can develop in the inlet line 250 and channel 260. If the blow-by gas overpressure gets high enough, it can damage the engine. The blow-off valve 400 prevents such damaging pressure by releasing the blow-by gas through the passage 410 when the pressure reaches the predetermined pressure.

The above-described roll-over valves close when the valve orientation changes from an upright position into an overturned position and the pistons move into roll-over positions. As illustrated in FIGS. 2 and 4, these overturned and roll-over positions include orientations where the valve rolls over a full 180 degrees and is completely upside down. However, overturned and roll-over positions according to the present invention also include orientations in which the valve is not completely overturned. For example, roll-over and overturned positions include positions in which the valve's vertical orientation only changes by a little more than 90 degrees. The roll-over valve may even be designed to move into its overturned position when the valve orientation changes by less than 90 degrees (for example, if the axis of the valve's cylinder is not vertically aligned when the valve is in its normal upright position).

While the illustrated pistons and cylinders have circular cross-sections, pistons and cylinders accordingly to alternative embodiments of the present invention have other cross-sectional shapes. For example, pistons and cylinders may have complementary oval or rectangular cross-sections without deviating from the scope of the present invention.

The illustrated roll-over valves are disposed in blow-by gas lines of blow-by gas circulation systems for engines. Accordingly, the operating fluid within these valves is blow-by gas, oil, lubricant, fuel, etc. However, roll-over valves according to the present invention may alternatively be utilized in a variety of other passageways. For example, a roll-over valve may be used in an open coolant circulation system of an engine. In such an embodiment, the operating fluid would comprise coolant. Alternatively, a roll-over valve according to the present invention may be used in any situation where it is advantageous to open or close a valve in a fluid line in response to an object's overturning.

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

What is claimed is:

1. A roll-over valve for a blow-by gas circulation system of an engine, the roll-over valve comprising:
a valve housing having an inner chamber that defines an axis, an inlet opening disposed in a lateral side of the valve housing, and an outlet opening disposed in the valve housing; and
a piston slidingly disposed in the inner chamber for movement relative to the valve housing along the axis, the piston having normal and roll-over positions relative to the valve housing, wherein the inlet and outlet openings fluidly connect to each other via the inner chamber when the piston is in the normal position, wherein the piston slides from its normal position to its roll-over position under the force of gravity when the valve rolls into an overturned position, and wherein the piston blocks at least one of the inlet and outlet openings to prevent fluid flow through the inner chamber when the piston is in its roll-over position.

2. The roll-over valve of claim 1, further comprising a blow-off valve fluidly connecting the inlet and outlet openings, wherein the blow-off valve opens when a pressure in the inlet opening exceeds a predetermined pressure relative to a pressure in the outlet opening.

3. The roll-over valve of claim 2, wherein the blow-off valve closes when the pressure in the inlet opening falls below the predetermined pressure.

4. The roll-over valve of claim 1, further comprising an air-bleed passage that fluidly connects portions of the inner chamber that are disposed on opposing axial sides of the piston.

5. The roll-over valve of claim 4, wherein the air-bleed passage has first and second opposing ends, wherein the first end of the air-bleed passage fluidly connects to a bottom axial portion of the inner chamber such that the first end aligns with the axis, and wherein the second end fluidly connects to the outlet opening.

6. The roll-over valve of claim 4, wherein the air-bleed passage comprises an axially extending bore in the piston.

7. The roll-over valve of claim 6, further comprising an inner piston slidingly disposed in the bore, wherein the inner piston has normal and roll-over positions relative to the piston, and wherein the inner piston blocks the air-bleed passage when the inner piston is in its roll-over position.

8. The roll-over valve of claim 7, wherein the inner piston has a guiding portion that has a polygonal cross-section that guides the inner piston along the axis of the bore.

9. The roll-over valve of claim 8, wherein the inner piston has a guiding portion that has a cross-sectional area that is at least 85% of a cross-sectional area of the surrounding bore.

10. The roll-over valve of claim 7, wherein the inner piston has a frusto-conical upper surface, and wherein an upper portion of the bore has a reduced diameter frusto-conical surface that seals against the frusto-conical upper surface of the inner piston when the inner piston moves into its roll-over position.

11. The roll-over valve of claim 1, wherein the inlet opening connects to the inner chamber at a position where any pressure that develops in the inlet opening does not urge the piston into the roll-over position.

12. The roll-over valve of claim 1, wherein the outlet opening is disposed at an upper axial end of the inner chamber.

13. The roll-over valve of claim 1, wherein an upper portion of the piston has a frusto-conical surface.

14. The roll-over valve of claim 13, wherein the outlet opening has a frusto-conical surface that seals against the frusto-conical surface of the piston when the piston is in the roll-over position.

15. The roll-over valve of claim 1 in combination with a blow-by gas circulation system comprising:
an oil tank having
an inlet adapted to accept blow-by gas from an engine, and
an upper portion that is adapted to be above an oil level in the oil tank when the oil tank is upright;
an oil separator having an inlet adapted to accept blow-by gas, and an outlet adapted to direct blow-by gas to an intake system of the engine; and
a blow-by gas line fluidly connecting the upper portion of the oil tank to the inlet of the oil separator,
wherein the roll-over valve is disposed in the blow-by gas line such that the inlet opening fluidly connects to the upper portion of the oil tank and the outlet opening fluidly connects to the inlet of the oil separator.

16. A blow-by gas system comprising:
an oil tank having
an inlet adapted to accept blow-by gas from an engine,
an upper portion that is adapted to be above an oil level in the oil tank when the oil tank is upright, and
a lower portion that is adapted to be above the oil level in the oil tank when the oil tank is overturned;
an oil separator having an inlet adapted to accept blow-by gas, and an outlet adapted to direct blow-by gas to an intake system of the engine;
a first blow-by gas line fluidly connecting the upper portion of the oil tank to the inlet of the oil separator;
a roll-over valve comprising a first valve portion that is disposed in the first blow-by gas line, wherein the roll-over valve has upright and overturned positions, wherein the first valve portion opens the first blow-by gas line when the roll-over valve is in the upright position, and wherein the first valve portion closes the first blow-by gas line when the roll-over valve is in the overturned position; and
a second blow-by gas line fluidly connecting the lower portion of the oil tank to the inlet of the oil separator.

17. The blow-by gas system of claim 16, wherein the first and second blow-by gas lines converge into a common blow-by gas line before reaching the inlet of the oil separator.

18. The blow-by gas system of claim 16, wherein the roll-over valve further comprises a second valve portion that is disposed in the second blow-by gas line, wherein the second valve portion closes the second blow-by gas line when the roll-over valve is in the upright position, and wherein the second valve portion opens the second blow-by gas line when the roll-over valve is in the overturned position.

19. The blow-by gas system of claim 18, further comprising an oil return line fluidly connecting the lower portion of the oil tank to the oil separator, wherein the roll-over valve further comprises a third valve portion that is disposed in the oil return line, wherein the third valve portion opens the oil return line when the roll-over valve is in the upright position, and wherein the third valve portion closes the oil return line when the roll-over valve is in the overturned position.

20. The blow-by gas system of claim 16, wherein the roll-over valve comprises:
a valve housing having an inner chamber and an axis, and
a piston slidingly disposed within the inner chamber,
wherein the piston is disposed in a normal position when the roll-over valve is in the upright position, and wherein the piston moves into a roll-over position when the roll-over valve is in the overturned position.

21. The blow-by gas system of claim 20, wherein the first valve portion comprises a first groove in the piston that aligns with opposing openings in the first blow-by gas line to permit fluid flow through the first blow-by gas line when the piston is in the normal position, and wherein the first groove misaligns with the opposing openings in the first blow-by gas line when the piston is in the roll-over position such that the piston prevents fluid flow through the first blow-by gas line.

22. The blow-by gas system of claim 21, wherein the roll-over valve further comprises a second valve portion that is disposed in the second blow-by gas line, the second valve portion comprising a second groove in the piston, the second groove aligning with opposing openings in the second blow-by gas line to allow fluid flow through the second blow-by gas line when the piston is in the roll-over position, the second groove misaligning with the opposing openings in the second blow-by gas line when the piston is in the normal position such that the piston prevents fluid flow through the second blow-by gas line.

23. The blow-by gas system of claim 22, further comprising an oil return line fluidly connecting the lower portion of the oil tank to the oil separator, wherein:
the roll-over valve further comprises a third valve portion that is disposed in the oil return line;
the third valve portion comprises a third groove in the piston that aligns with opposing openings of the oil return line to allow fluid to flow through the oil return line when the piston is in the normal position; and
the third groove misaligns with the opposing openings in the oil return line when the piston is in the roll-over position such that the piston prevents fluid flow through the oil return line.

24. The blow-by gas system of claim 21, wherein the piston has an axial bore extending therethrough.

25. The blow-by gas system of claim 24, wherein the piston has a first radial bore fluidly connecting the first groove to the axial bore, and wherein the piston has a second radial bore fluidly connecting the third groove to the axial bore.
